(19) United States
(12) Patent Application Publication
(10) Pub. No.: US 2026/0340329 A1
(43) Pub. Date: Oct. 29, 2026

(54) SLIDE IDENTIFICATION FOR IMAGING DEVICES

(71) Applicant: Huron Technologies International Inc., St. Jacobs (CA)

(72) Inventors: Audil Virk, St. Jacobs (CA); Savvas Damaskinos, St. Jacobs (CA); Drew Anderson, St. Jacobs (CA); Brian Doody, St. Jacobs (CA)

(21) Appl. No.: 19/655,146

(22) Filed: Apr. 22, 2026

Related U.S. Application Data
(60) Provisional application No. 63/793,295, filed on Apr. 23, 2025.

(51) Int. Cl. G06K 7/10; G06K 7/14

(52) U.S. Cl. CPC G06K 7/10722; G06K 7/1413; G06K 7/1417

(57) ABSTRACT

According to some aspects, a slide for use with an imaging device, having a first surface for receiving an object of interest thereon, and one or more edges, at least one of the one or more edges having at least one barcode thereon, each barcode sized and shaped to be readable by a barcode reader. In some cases, the barcode is readable by the barcode reader when the first surface of the slide is at least partially obscured.

### TECHNICAL FIELD

The described embodiments herein relate generally to imaging devices, such as scanners for biological specimens or other data of interest, and more specifically to improvements in identifying slides for imaging devices.

### INTRODUCTION

Imaging devices, such as scanners, are often used to examine objects of interest, such biological specimens, photographs, or other data. These objects of interest are often mounted onto thin plates or slides that allow them to more easily be handled, particularly without contacting or contaminating the object of interest. For example, in the medical field, pathologists often examine tissue specimens or samples on a slide made of glass or other media.

Sometimes slides are examined manually, but more commonly they are examined with the assistance of imaging tools, including optical scanners. The slides can be received in the scanners, often using automatic feeding processes, and cameras take one or more images of the object of interest on each slide. After imaging, the slides can be returned to storage (such as in a storage cassette), and in some cases will be archived.

The accurate and efficient identification of slides helps improve the reliability of the imaging process. However, with the ever-increasing complexity and volume of laboratory work, slide management processes are prone to delays and errors. This can lead to potential misidentification or even the loss of specimens, delays in diagnosis, degradation of the patient outcomes and in some cases compromises in patient safety.

One approach to slide management involves using barcodes, which as used herein generally means any graphical representation of data in a visual, machine-readable form. For example, barcodes can include one dimensional barcodes (sometimes called linear barcodes) and two-dimensional barcodes or matrix codes (also known as QR barcodes or simply QR codes), as well as other formats (including non-traditional graphics or other symbols).

Barcodes provide a reasonably efficient method for encoding information in a machine-readable format such that desired information can be scanned and retrieved when needed using an optical barcode reader.

In pathology applications, barcodes can be applied to specimen containers, slides, and other equipment or materials to enable tracking and identification. For example, slides can be tracked using barcodes as they move through different steps in a scanning process (i.e., from storage, transport, scanning, and archiving).

Barcode technology can enhance the accuracy of slide handling as well as improve the efficiency of laboratory operations, for example by reducing time spent on manual data entry and verification.

The use of barcodes in pathology can also support the automation of routine tasks, such as specimen registration, tracking, and the recording of results.

The use of barcodes may also facilitate integration with laboratory information systems (LIS), helping to ensure that data associated with a specimen or other object of interest can be correctly linked and easily accessible. This level of integration is useful for maintaining chain of custody, ensuring compliance with regulatory standards, and ultimately for delivering higher-quality patient care.

As pathology laboratories continue to adopt more advanced digital tools, barcodes remain a foundational technology that underpins the accuracy and reliability of diagnostic processes. By reducing the risk of human error and streamlining workflows, barcodes play a useful role in modernizing pathology practices and enhancing the overall efficiency and quality of laboratory services.

### BRIEF DESCRIPTION OF THE DRAWINGS

For a better understanding of the various embodiments described herein, and to show more clearly how these various embodiments may be carried into effect, reference will be made, by way of example, to the accompanying drawings, which show at least one example embodiment. The drawings are not intended to limit the scope of the teachings described herein.

Embodiments will be described in greater detail below with reference to the drawings, in which:

FIG. 1A is an exemplary schematic of a one-dimensional or linear barcode for use with a barcode reader;

FIG. 1B is an exemplary schematic of a two-dimensional QR barcode for use with a barcode reader;

FIG. 2A is an exemplary schematic of a linear barcode on a label according to one embodiment;

FIG. 2B is an exemplary schematic of a QR barcode on a label according to another embodiment;

FIG. 3 is an exemplary schematic of a slide having a linear barcode according to one embodiment, showing top, bottom, plan and side views;

FIG. 4 is an exemplary schematic of a slide having a QR barcode according to another embodiment, showing top, bottom, plan and side views;

FIG. 5 is an exemplary perspective drawing of slides received in a slide container, each slide having a barcode on a label placed on the same surface as the object of interest;

FIG. 6 is an exemplary schematic of a slide with a linear barcode on one or more edges of a slide according to one embodiment, showing top, bottom, plan and side views;

FIG. 7 is an exemplary schematic of a slide with a QR barcode on one or more edges of a slide according to another embodiment, showing top, bottom, plan and side views;

FIGS. 8a to 8c are exemplary schematics of a slide with a linear barcode on an edge of a slide and having a label folded over the edge of the slide according to another embodiment;

FIG. 8d is an exemplary schematic of slides of the type shown in FIGS. 8a to 8c received in a slide carrier;

FIGS. 9a to 9c illustrate exemplary schematics of a slide featuring two QR barcodes: one positioned along the edge of the slide, and another on the top, via a label that folds over the edge of the slide, in accordance with another embodiment.

FIG. 10a is an exemplary perspective drawing of slides in a container, one having a linear barcode and the other having a two-dimensional barcode, each barcode positioned on an edge of the respective slide and being visible by an optical scanner while the slides are in the container;

FIG. 10b is a plan view of the pathology slides of FIG. 10a; and

FIG. 11 is an exemplary perspective drawing of an optical barcode reader reading the barcodes on the edges of slides while they are within a container according to one embodiment;

The drawings, described in greater detail below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF SOME EXEMPLARY EMBODIMENTS

The described embodiments herein relate generally to imaging devices such as scanners for use in imaging objects of interest on thin plates or slides. The objects of interest could be any item, material, or sample from any source or for any purpose, such as biological specimens, non-biological specimens, photographs, crystals, or other items.

For example, in medical applications, a slide is typically prepared with the physical tissue specimen mounted thereon (such as from a biopsy). The slides are generally thin and planar in shape, and are often made of glass, plastic or another suitable substrate. Often the substrate is at least partially transparent to allow at least some light to pass through for the purposes of illuminating the sample, but that need not necessarily be the case.

Once mounted on the slide, a tissue specimen may be scanned in a digital pathology process (i.e., by a high-capacity digital scanner). This scanning creates one or more high-resolution digital images of the tissue sample. These images can then be subsequently examined (i.e., by a pathologist or other medical expert) for the purposes of diagnosis.

Barcodes are useful with digital pathology scanners. The integration of barcode technology into the digital pathology process can help ensure accurate identification, tracking, and management of specimens throughout the scanning and analysis phases.

Barcodes use with digital pathology scanners can include:
(a) specimen identification and preparation, where each glass slide and/or specimen container is labeled with a unique barcode that encodes (and/or links to) pertinent information, such as a patient's identification number, specimen type, and case number;
(b) serving as a unique identifier, ensuring that each slide is correctly matched with its corresponding patient records and clinical data;
automated workflow integration, wherein, before scanning, a digital pathology scanner (or a handheld and/or independently mounted barcode reader, or any other piece of laboratory or processing equipment that handles or stores slides) reads the barcode on the slide, automatically pulling up the relevant information from a Laboratory Information System (LIS). This integration ensures that the scanner can associate the correct metadata (such as patient details, tissue type, staining information, etc.) with the scanned digital image, typically without additional and error-prone manual data entry;
(d) accurate image acquisition, wherein the scanner uses a barcode to track a slide throughout the scanning process, ensuring that the digital image corresponds accurately to the physical slide. This reduces the risk of mislabeling or mismatching images, which could lead to diagnostic errors; and
(e) efficient data management, once the slide is scanned, allowing the digital image to be automatically linked to the barcode in the LIS, thus allowing pathologists to more easily retrieve an image and its associated data for analysis.

Using a barcode helps ensure that all desired information travels (or can be retrieved in association) with the corresponding digital image, facilitating communication between different systems and professionals. By incorporating the use of barcodes into imaging devices such as digital pathology scanners and/or any equipment used to handle or store slides, laboratories can reduce the likelihood of errors, improve efficiency, and maintain higher levels of accuracy in diagnostic processes. This integration ensures that the workflow is not only faster but also more reliable, ultimately contributing to better patient outcomes.

### One Approach: Barcode Placed on Slide Surface With Sample

One approach to using barcodes for slide management involves placing a barcode on the same surface as the object of interest. For example, on a pathology slide a barcode may be placed in a specific location on the upper flat surface of the slide that also receives the sample of interest. Normally this is beside the sample but spaced so as not to obscure the tissue sample or interfere with the scanning process.

A barcode can be placed on the top planar surface of the slide in an area defined as the “label area”. When the object of interest is in the middle of the slide (as is common), the label area will typically be located on either side of the object of interest towards one end (sometimes referred to as the “frosted end” or “label end”).

This “label end” of the slide surface is reserved for labeling and does not contain any tissue specimen. A barcode may be affixed or printed on the label (typically a plastic or paper label). The label may also include other human readable information, including for example identifying information such as the patient's name, case number, date of collection, and so on.

Regardless of the exact placement, a barcode is removed from a storage device (i.e., a cassette) and placed in a scanner, the barcode can be read by a barcode reader. In some cases, the barcode reader is positioned near the imaging scanner that images the object of interest. This is done in a way that does not compromise the visibility of the tissue sample or the quality of the scanned image.

Unfortunately, the placement of barcodes on the slide surface adjacent the sample does have problems. While such barcode placement allows each barcode to be read as part of the process of imaging the sample (and the barcode can be read immediately before or after digitizing the tissue sample), each slide must be removed from its carrier or holder before the barcode can be scanned.

Accurately and efficiently reading a barcode of one or more slides while the slides are still located within a carrier is generally not possible, as the plurality of slides in the carriers obstruct each other. This is particularly true in carriers where the spacing between adjacent slides is quite narrow or even where the slides are in contact with other adjacent slides. As a result, there is no practical way to scan barcodes placed on the slide surface while the slides are in the carrier.

### Improvements To Barcode Functionality

The present teachings generally provide a solution to this technical challenge.

Some embodiments herein may enable identification of slides while they are located within a slide carrier, such as a cassette. This can enable a determination of which particular cassette (or carrier) contains each particular slide, and/or the position of each slide within each particular cassette at one or more times, without removing the slides from the cassette. In this manner, the scanning system can become more flexible and more informed about not only a single slide that is in the process of being scanned, but also what other slides are available for scanning and/or have already been scanned.

These techniques are not limited to the imaging of biological samples, and may also be applicable to any application where identification of data contained on thin panels or objects is useful, extending their utility beyond pathology to other domains.

According to some exemplary embodiments as described herein, therefore, and to enhance the efficiency and accuracy of slide management in digital pathology, it has been discovered that it may be advantageous to place a barcode along one or more edges of a slide as opposed to merely on the surface of the slide.

In general, the edge of the slide may be perpendicular to the planar surface of the slide.

Positioning a barcode in this manner on one or more edges is counterintuitive, as the edge of a slide is typically quite thin, and small, and does not readily provide a large surface area to be scanned by an optical reader. Nevertheless, when used properly this approach is beneficial as it can allow barcodes on one or more slides to be read while the slides are still located inside a cassette or other carrier. This therefore eliminates the need to remove each slide individually for scanning the barcode thereof and identifying the slide.

According to one example, a barcode (such as a linear or one-dimensional barcode, or a two-dimensional barcode) could be provided on one or more edges of a slide. For example, a linear barcode could be laser printed on an edge of a slide, etched, printed on an edge using ink, printed on a label affixed to one or more edges, or generally provided on the edge in some other manner.

According to one embodiment, one or more barcodes can be provided on a label (i.e., printed on the label), and the label can be folded over an edge of the slide, positioning the barcode along at least a portion of the edge. In some cases, at least a portion of the barcode may be positioned on both an edge of the slide but also on one or more of the top surface of the slide and the bottom surface of the slide.

Positioning barcodes along the edges of slides (as opposed to the surface where the tissue samples are mounted) allows the barcodes to be read while the slides are contained inside a cassette or carrier. In some embodiments, this can be done regardless of whether the container with the slides is outside or inside of the image scanner.

Exposing the barcodes along the edges in this manner can provide for more continuous visibility of the slides within a carrier. This can allow for improved tracking the location of one or more slides during a digital pathology process. This can have various benefits.

For instance, it may enable priority scanning of specific slides as desired. In particular, if a user desires to scan a particular slide at a particular time, such as out of an ordinary sequence, it will generally be easier to locate that particular slide within the carrier, and then select that slide for prioritized scanning. This could be done by scanning the barcodes of all the slides within one or more carriers (in some cases by simultaneously scanning all the barcodes), and then selecting the slide of interest to be digitized. This might be beneficial for an urgent case where patient condition has deteriorated, and prioritizing the scanning becomes important for patient health.

Another benefit may be related to increased throughput. Allowing barcodes on slides to be read while the slides are still in a carrier may reduce the need for manual handling of slides, and/or eliminate scanning within the imaging machine, which can help streamline the scanning process and may increase overall throughput.

### Drawbacks of Barcodes on the Surface with the Sample

In general, using barcodes on the surface of slides (where the sample is located) has several drawbacks.

The first drawback is the time-consuming nature of slide identification. With barcodes on the surface with the sample, the barcode on each slide must be scanned individually before determining the slide location within the digital scanner. This takes time and can lead to delays. For instance, in a digital scanner holding 500 slides, it may take two seconds to scan each barcode of each slide (including the time taken to remove the slide from a carrier, and to place the slide in a position suitable for barcode reading). In this example, the total time required to scan the 500 slides could be approximately 1,000 seconds (about 16.7 minutes) or more.

Additionally, positioning each cassette to be read by the sensor adds more time. Using a Sakura cassette that holds 20 slides as an example, scanning the barcodes of 25 cassettes (around 500 slides) could take around approximately 2 minutes. The total time combined time for barcode reading and cassette presentation in this example adds up to around 19 minutes.

Given that modern digital scanners can scan a typical slide (15 mm by 15 mm image area) in 30 seconds, with a throughput of approximately 100-120 slides per hour after accounting for mechanical and computing overhead, with approximately 500-600 slides could ideally be scanned in 5 hours. However, the added time for barcode reading reduces digitization throughput from approximately 100-120 slides per hour to approximately 93 slides per hour, negatively impacting overall efficiency.

Improving barcode placement and streamlining this process using the teachings as described herein can thus substantially improve the throughput and accuracy of digital scanning workflows in pathology labs.

### Summary of Various Exemplary Embodiments

In a first exemplary embodiment, a one-dimensional (i.e., a 1D or linear barcode) is printed on a label. One portion of this label is then mounted on a slide, usually on the front of the slide near one end, covering approximately 15 mm thereof. It will be noted that all sizes as used herein are exemplary only, and larger or smaller sizes can of course be used depending on the particular application and technology being used.

The label can then be wrapped around an edge of the slide so that the barcode is visible along at least one edge of the slide, even when the slide is mounted in a carrier.

In some examples, the thickness of a typical slide is approximately 1 mm, in which case the height of the barcode may be less than 1 mm (or it may be larger and wrap over onto one or more of the top and bottom of the slide).

In some examples, the width of a typically pathology slide is greater than 24 mm, in which case the length of the barcode may be up to 24 mm (or another suitable length based on the width of the particular slide being used). This is significantly less surface area than is normally available on the surface of the slides. However, it can provide some unexpected benefits.

In particular, using a linear barcode on an edge of the slide can be read by a barcode reader that is suitably positioned even if a plurality of slides are stacked together, since the barcodes can be read without separating or moving the slides (removing them from a cassette, for example). This allows slide barcodes to be read when there is little or no gap between them.

In some cases, the barcode reader may be operable to read all the slides in one single pass. For example, the barcode reader could include a large field digital imaging device that captures all barcodes in the field of view, and identifies each one in turn. In other cases, the barcode reader may read one slide at a time, and slides and/or the barcode reader may be moved relative to each other to facilitate reading each barcodes.

In a second exemplary embodiment, a two-dimensional barcode (i.e., “2D barcode”, such as a QR barcode) is printed on a label. As above, the label can then be mounted on a slide and wrapped around the edge of the slide so that the two-dimensional barcode is visible along at least one edge of the slide.

As discussed above, the thickness of some typical slides may be approximately 1 mm so that the height of the two-dimensional barcode could be less than 1 mm.

In general, two-dimensional barcodes may have different shapes. Some are square in shape, while others may be rectangular, triangular, or have any other suitable appearance.

In some cases, the width of a standard pathology slide is typically greater than 24 mm, such that a square two-dimensional barcode may be quite small relative to the width of the slide, and the barcode could be placed at different locations along the width of the slide (or even in multiple locations).

As with the linear barcode, a two-dimensional barcode can be read by an barcode reader so that the barcodes of slides that are stacked can be read without removing the slides (i.e., without removing them from a cassette).

In a third exemplary embodiment, a barcode such as a linear barcode may be provided directly onto the edge of a slide using, for example, a laser device, ink, etching, carving, or some other technique.

In a fourth exemplary embodiment, a barcode such as a two-dimensional barcode may be provided directly onto the edge of a slide using, for example, a laser device, ink, etching, carving, or some other technique.

In a fifth exemplary embodiment, a linear barcode may be located on the edge of slides as described in the first or third embodiment. The slides are then inserted into a container or carrier. The container could be, for example, a Sakura cassette with a slide capacity of 20 1″×3″ slides, an Epredia™ basket with a slide capacity of 20 1″×3″ slides, a Leica cassette with a slide capacity of 30 1″×3″ slides, or any other similar slide container.

One characteristic of these cassettes/baskets/cartridges is that the edges of the slides are typically at least partially exposed so that the slides can be readily grasped to be removed therefrom (in some cases by a robotic gripper). Other slide containers used in digital pathology slide scanners also typically have at least one edge of each slide exposed. One or more image sensors (i.e., barcode readers) can be mounted facing the barcodes on the edges of the slides, allowing the sensor to read the barcodes generally without needing displacement or motion of the slides inside the cassette.

In a sixth exemplary embodiment, a two-dimensional barcode is located on an edge of each slide, as described in the second or fourth embodiment, and the slides are inserted in a container (as described above with respect to the fifth embodiment).

In a seventh exemplary embodiment, a linear barcode is provided on the edges of slides as described in the first or third embodiment above. The slides are then inserted into a container. As described in the fifth embodiment, the slide containers can then be inserted into an imaging device, for example a high-capacity digital pathology slide scanner.

The edges of the slides inside the cassette (that is in the scanner) are exposed and visible to one or more image sensors (i.e., barcode readers) mounted inside the imaging device. The barcode of each slide may therefore be read generally without displacement or motion of the slides within the cassette/basket/cartridge while inside the imaging machine.

Since a scanner can often receive more than one cassette, the barcodes of some or all slides inside the imaging device can be read and the location of each slide of the plurality of slides inside the scanner may be determined. This may be advantageous for setting slide scanning priorities, allowing more urgent slides to be scanned sooner as desired.

In an eighth exemplary embodiment of the invention, a two-dimensional barcode may be provided on the edges of slides as described in the second or fourth embodiment, and then used as described above with respect to the seventh exemplary embodiment.

In some cases, the barcode reader may be independent of the slide scanner. For example, the barcode reader could be a standalone or handheld unit, or may be located in other equipment used to handle or store slides or the containers or cassettes holding the slides, and allowing the bar codes to be read without removal from any such containers or cassettes and prior to the containers or cassettes being placed into the imaging device.

### Detailed Discussion of the Embodiments Referencing the Figures

Turning now more specifically to the Figures, various exemplary embodiments will be described with reference thereto to more fully appreciate the teachings herein.

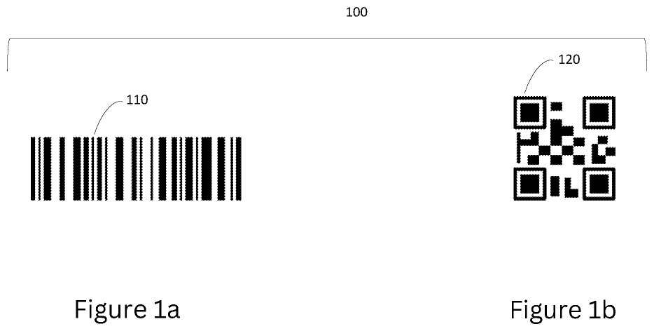

In particular, FIGS. 1a and 1b show exemplary representations 100 of barcodes, including a linear barcode 110 (also called a one-dimensional or “1D” barcode), and a two-dimensional (“2D”) barcode 120 (shown here as a QR barcode, but which could be another similar barcode). It will appreciated that term barcode as used herein should be interpreted expansively, and could include any graphical representation of data in a visual, machine-readable form. This could include bars, lines, squares, triangles, polygons, other images and characters, and generally any visual indicator (i.e., emojis, alphanumeric characters, etc.) that could read by an optical scanner.

Generally, barcodes are used to encode relevant information of a product including identification and tracking, among other purposes.

In pathology, barcodes are used to streamline and enhance the accuracy of various processes related to specimen management, data tracking, and reporting. Some specific ways barcodes are used in pathology include, but are not limited to, specimen identification where barcodes are applied to specimen containers, such as slides, vials, and tissue samples, to ensure that each sample is accurately identified and tracked throughout the testing process. This reduces the risk of mix-ups and ensures that the correct diagnosis is associated with the correct patient.

Another use for barcodes is tracking and workflow management, where barcodes help track the movement of specimens through different stages of the pathology workflow, from collection and transportation to processing, analysis, and storage. This improves efficiency and may allow for real-time monitoring of where each specimen is in the process.

Yet another use of barcodes is in data entry and retrieval, where barcodes allow for the quick and accurate entry of specimen data into laboratory information systems (LIS). Scanning a barcode can quickly retrieve all associated information, reducing manual data entry errors and speeding up the process. By using barcodes, pathology labs can significantly reduce errors, improve efficiency, and enhance the accuracy and reliability of diagnostic results.

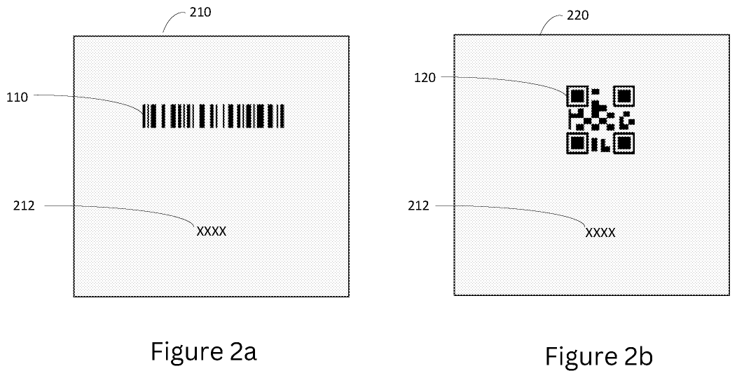

Turning now to FIGS. 2a and 2b, shown therein are example diagrams of labels that incorporate barcodes. In particular, FIG. 2a shows a label 210 that includes a linear barcode 110, and optionally alphanumeric text-based information 212 (as detailed further below). The label may be made of paper, plastic, or another suitable material for affixing to a slide.

In FIG. 2b, another label 220 is shown. This label 220 includes a different type of barcode, namely QR barcode 120, as well as text-based information 212.

In pathology, the label on a pathology slide typically contains human-readable text-based information to ensure accurate identification, tracking, and interpretation of the specimen. In general, the label may include:

Patient Identification information (i.e., Patient Name, Patient ID Number, Date of Birth);

Specimen Information (i.e., Accession Number, Specimen Type, Anatomical Site, etc.); and

Slide-Specific Information (i.e., Stain or Special Procedure, Slide Number, etc.).

This information helps ensure that each slide can be accurately associated with the correct patient and specimen, reducing the risk of errors, and facilitating proper diagnosis and treatment.

Although not meant to be limiting, the typical size of a pathology label on a typical 1″×3″ slide (a slide size commonly used in pathology labs) usually ranges from 0.5″×1″ to 0.75″×1.5″. The label is designed to fit neatly onto one end of the surface of the slide (the “label end”), leaving most of the slide surface free for the tissue specimen. These label dimensions generally allow enough space to include information such as the patient ID, specimen details, and a barcode, while ensuring the label does not obscure the specimen or interfere with slide handling and storage. The label size can vary depending on the amount of information that needs to be included and the specific labeling practices of a pathology lab.

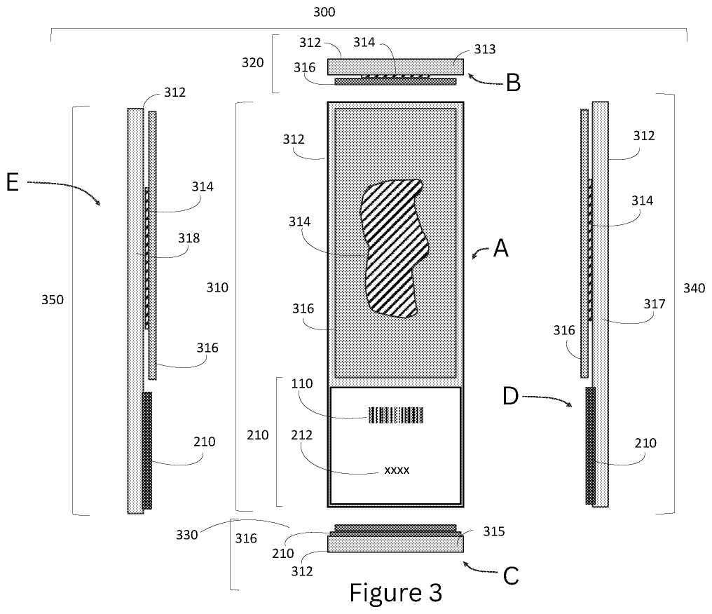

Turning now to FIG. 3, illustrated therein are various views of an example pathology slide 300. In this example, the slide 300 is shown in a plan view 310 (also labeled as “A”, showing the large surface of the slide 300 onto which the tissue sample 314 is mounted beside a label 210). FIG. 3 also shows a top end view 320 of the slide 300 (also labeled as “B”), a bottom end view 330 of the slide 300 (also labeled as “C”), a right-side view 340 of the slide 300 along its length (also labeled as “D”), and a left side view 350 along its length (also labeled as “E”).

The plan view 310 of the pathology slide shows the large planar surface of the slide substrate 312, which is typically made of glass, plastic or another suitable material. As shown in the top end view 320 and bottom end view 330, the thickness of the glass in this example is typically around 1.0 to 1.2 mm.

As shown in the plan view 310, an object of interest 314 such as a tissue specimen (which could be a thin slice of tissue, cells, or other biological material) is mounted on the slide substrate 312. In some examples, such as where the object of interest 314 is a tissue sample, the sample specimen 314 could be stained with specific dyes to enhance contrast and visibility of the structures within the specimen.

In this example the specimen 314 is a thin slice of tissue. The typical thickness of tissue sections placed on pathology glass slides is usually 4 to 5 micrometers (μm). However, in some research the tissue slices can be as thick as 100 μm.

Once the specimen 314 is placed on the slide, it is usually covered with a thin piece of glass called a coverslip 316 to protect the specimen 314 and facilitate viewing of the specimen 314 under the microscope.

The plan view 310 of pathology slide 300 also shows the label 210. As shown, the label 210 is on the surface of the substrate 312 near the bottom of the pathology slide 300.

The label 210 in this example contains a linear barcode 110 and text 212. The combination of the linear barcode 110 and text 212 are placed/printed on the label 210 to capture all the desired information relevant to the object of interest.

Looking more closely, the top end view 320 shows the thickness of the glass slide substrate 312, the thickness of the tissue section 314, and thickness of the coverslip 316. In general, the thickness of the glass slide substrate 312 defines a top edge 313 of the slide 300.

The bottom end view 330 again shows the glass substrate 312, as well as the label 210, and the coverslip 316. The tissue sample 314 is not visible in the end view 330 as the tissue sample 314 is obscured by the thickness of the label 210. In general, the thickness of the glass substrate 312 defines a bottom edge 315 of the slide 300.

The right-side view 340 of the slide 300 again shows the slide substrate 312, and the tissue section 314 covered by the coverslip 316. Near the bottom of the slide 300, the label 210 is also shown. In general, the thickness of the glass slide substrate 312 defines side edge 317 of the slide 300.

The left-side view 350 of the slide 300 again shows the slide substrate 312, and the tissue section 314 covered by the coverslip 316. Near the bottom of the slide 300, the label 210 is also shown. In general, the thickness of the glass slide substrate 312 defines side edge 318 of the slide 300.

Notably, in FIG. 3 the barcode 110, and text 212 of the label 210 are typically only visible in the plan view 310 of the slide 300, and are not visible along any of the edges 313, 315, 317 of the slide 300. Thus, the only way to view the information on label 210 is from above (i.e., using the plan view 310).

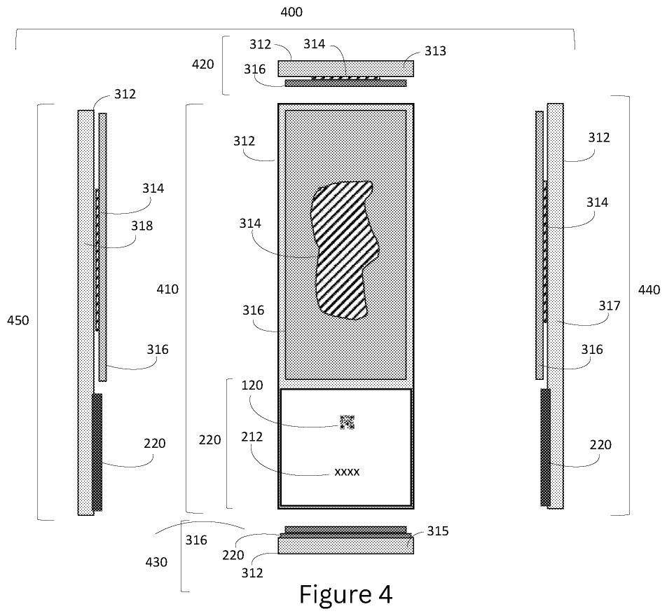

Turning now to FIG. 4, illustrated therein is another example of a pathology slide 400 according to another embodiment.

In this example, the slide 400 is similar to slide 300, and is shown with a plan view 410 (showing the large surface of the slide 300 onto which the tissue sample 314 is mounted beside a label 220). FIG. 4 also shows a top end view 420 of the slide 400, a bottom end view 430 of the slide 400, right-side view 440 of the slide 400 along its length, and left-side view 450 of the slide 400.

In fact, slide 400 may be generally identical to slide 300 described above, with the exception that the label 220 on slide 400 includes a 2D barcode 120 instead of a linear barcode 110.

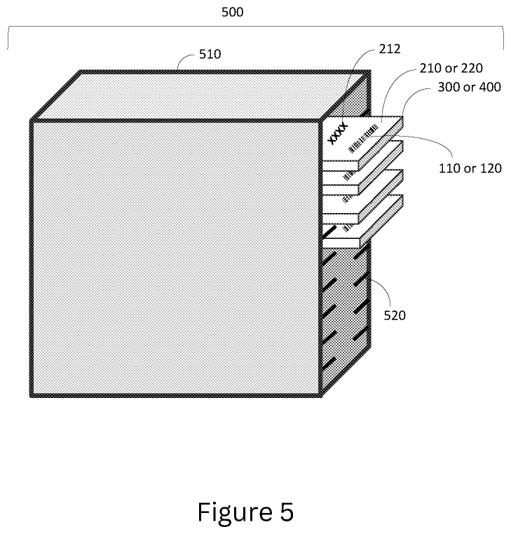

Turning now to FIG. 5, illustrated therein is an example of a pathology slide container 510 with a plurality of pathology slides located therein (i.e., a plurality of slides 300 or 400, although only four slides are shown in this example for clarity). Pathology slides 300 or 400 include a barcode (i.e., linear barcode 110 or 2D barcode 120) on the label 210 or 220 on the surface of the pathology slide 300 or 400 as described above.

In general, as shown the labels 210/220 400 are located toward one end of the slides 300 or 400 (the “label end”), while the slides 300 or 400 are supported by slots 520 in the container 510. In general, as shown in this embodiment, the depth of the pathology slide container 510 is less than the length (76 mm) of standard pathology slides 300 or 400 by 10 to 20 mm. As such, slides in the container will protrude and can be grasped for removal.

When pathology slides 300 or 400 are inserted into container 510, even though the labels 210 or 220 of each pathology slide 300 or 400 are near the end of each slide 300 or 400, they are generally only visible from above, as other slides (particularly adjacent slides) will obstruct visibility of the barcodes.

In particular, when the pathology slides 300 or 400 are in a fully inserted position in a container 510, only a portion of the slide (usually the side where the label is located) is partially exposed. This is done for practical reasons so that extraction of slides can be done (either manually by a user or by a robotic arm, e.g., a slide gripper).

When container 510 is loaded with pathology slides 300 or 400, the only barcode 110 or 120 that is visible to a barcode reader for reading purposes without retracting slide 300 or 400 is the barcode at the uppermost location (i.e., the top slide in the stack of slides) in the uppermost slot 520 of container 510.

The barcodes 110 or 220 of the rest of pathology slides 300 or 400 (i.e., slides lower down in the container) are typically obstructed by the other slides and hence their barcodes will not be visible to a barcode reader unless the slides are pulled out from the container 510. Removing slides from the container 510 to read barcodes can be time consuming. As such, this is a less than desirable configuration.

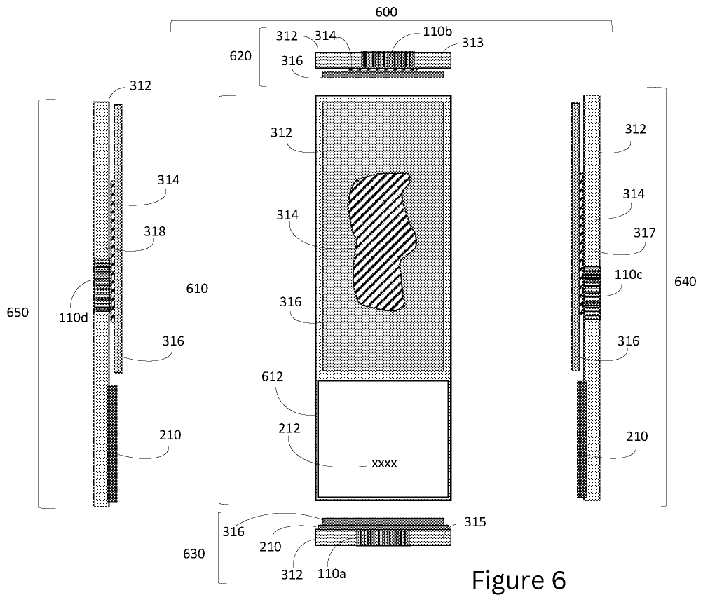

Turning now to FIG. 6, illustrated therein is an exemplary pathology slide barcode arrangement according to the teachings herein. In this example the slide 600 is shown with a plan view 610 (showing the large surface of the slide 600 onto which the tissue sample 314 is mounted beside a label 612). FIG. 6 also shows a top end view 620 of the slide 600, a bottom end view 630 of the slide 600, a left-side view 650 of the slide 600 along its length, and a right-side view 640 of the slide 600 along its length.

In this example, barcodes are provided on one or more edges of the slides.

For example, a linear barcode 110a has been printed/etched onto the lower edge 315 of slide glass substrate 312 of exemplary pathology slide 600. Other linear barcodes 110b, 110c, and 110d have been printed/etched directly onto the other three edges 317, 313, 318 as may optionally be desired depending upon the workflow or equipment configuration.

The barcodes 110a, 110b, 110c, 110d may have been laser etched onto any of the edges 315, 313, 317 or 318 or printed thereon using ink, or otherwise directly applied to the slide 600.

In some cases more than one barcode can be provided on one or more edges of the slide 600. In some cases, the barcodes may be the same. In some cases, the barcodes may be different.

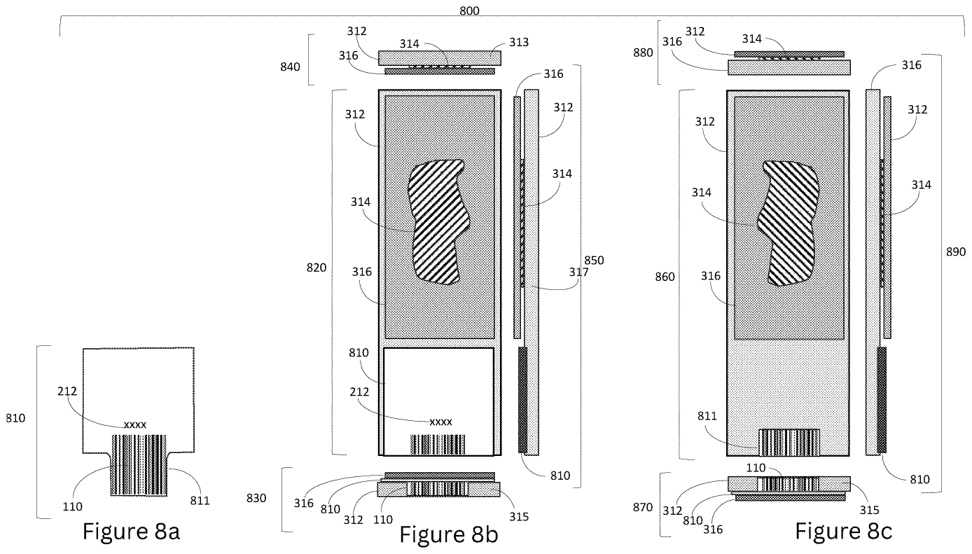

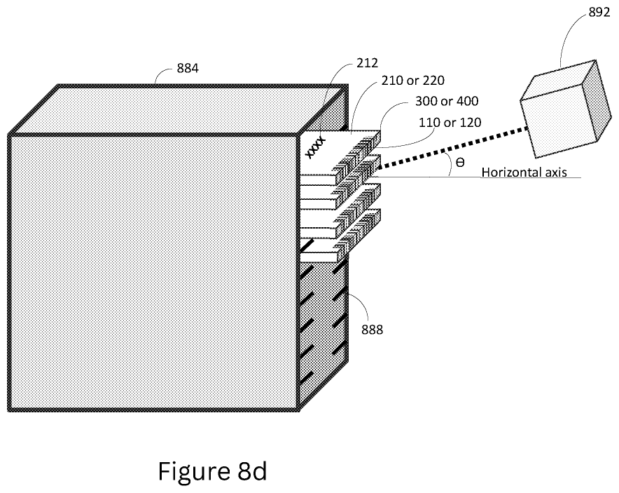

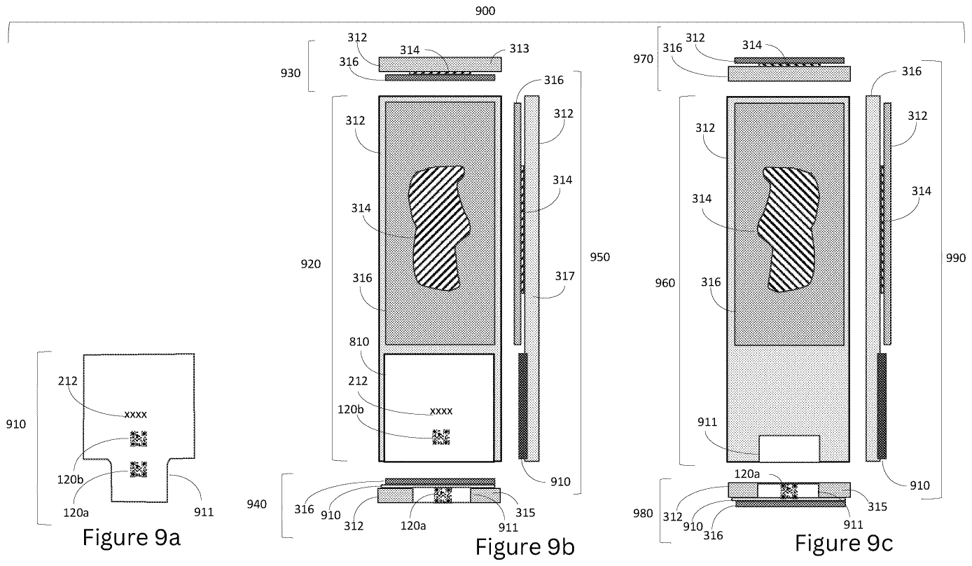

As shown, slide 600 still has a label 612 placed near the bottom of the pathology slide 600, but which contains only text 212 of relevant information to a pathology case. In some other cases, a copy of the barcode 110 could also be provided on the label (as discussed below with respect to FIGS. 8 and 9, for example).

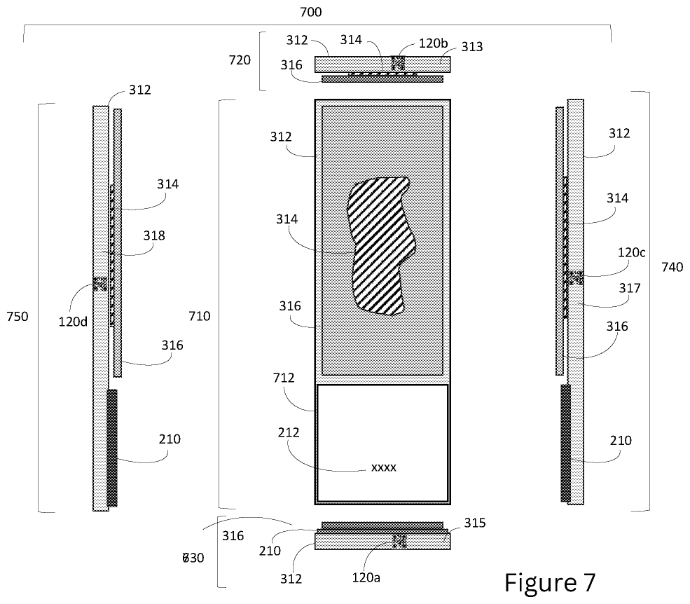

Turning now to FIG. 7, illustrated therein is an exemplary pathology slide barcode arrangement according to another embodiment. In this example the slide 700 is shown with a plan view 710 (showing the large surface of the slide 700 onto which the tissue sample 314 is mounted beside a label 712). FIG. 7 also shows a top end view 720 of the slide 700, a bottom end view 730 of the slide 700, a left-side view 750 of the slide 700 along its length, and a right-side view 740 of the slide 700 along its length.

In this example, slide 700 is generally similar to slide 600 above, except that a 2D barcode 120a is present along the edge 315 instead of a linear barcode 110. Also shown, other barcodes 210b, 210c, 210d have been printed/etched directly onto the other three edges 317, 313, 318 as may optionally be required or desired depending upon the workflow or equipment configuration.

As shown, the label 712 in this example is placed near the bottom of the pathology slide 700 and contains only text 212 of relevant information to a pathology case. In some other cases, a copy of the barcode 120 could also be provided on the label 712.

Turning now to FIGS. 8a, 8b, and 8c, illustrated therein is an example pathology slide 800 with a barcode (in this example a linear barcode 110) on the bottom edge 315 of slide substrate 312. In particular, the barcode 110 has been printed on a label 810 and then folded over the edge 315, in some cases onto the opposite side or bottom of the slide substrate 312 (i.e., generally wrapping around the slide 800).

In particular, FIG. 8a shows an example label 810. The label 810 as shown may have a narrow portion 811 and is designed to be folded over the bottom edge 315 of the slide 800 (although it will be appreciated that in other embodiments the label 810 could be folded over other edges of the slide 800, such as a top edge 313).

In this example, the label 810 includes text 212 and a linear barcode 110 printed on the narrow portion 811 of the label 810. Furthermore, in this example the barcode 110 is printed tall enough (in the vertical direction) on the label such that it can be viewed on both the edge 315 that it folds over onto, as well as on the top surface of the slide 800 in a region adjacent the slide edge 315.

Turning now to FIG. 8b, the slide 800 is shown with a plan view 820, a top end view 830, a bottom end view 840, and right-side view 850 along its length. As will be appreciated, since in this example the barcode 110 is printed tall enough in the vertical direction on label 810 such that a portion of the barcode 110 on the label 810 is visible on the top surface slide 800 generally adjacent the edge 315.

The bottom end view 830 shows the linear barcode 110 of the label 810 that has been folded over the edge 315 of the slide 800.

This makes placement and alignment of the barcode on the edge surface simple, self-aligning, and not prone to errors or misapplication of the barcode on the narrow slide edge, and also provides identification on the top surface of the slide. Additionally, text 212 of relevant information to a pathology case, or information relevant in any way to the object of interest in a more general application, is visible in the plan view 820 of the slide 800 in this embodiment.

FIG. 8c, on the other hand, shows a rear plan view 860, as well as inverted top and bottom views 870, 880 and a left side view 890. The rear plan view 860 in particular shows the portion of the narrow end 811 of label 810 folded over the slide glass substrate 312 onto the back of pathology slide 800. Since the barcode 110 is printed tall (in the vertical direction) to the bottom of the narrow end 811 of label 810 it is also visible in rear plan view 860 in an area adjacent the edge 315.

Having at least a portion of the barcode 110 visible on a top surface (or indeed the bottom surface) can be beneficial as shown in FIG. 8d. In particular, a barcode reader 892 that is attempting to read the barcode 110 can receive information from not only the portion of the barcode 110 on the edge 315, but can also read information from the surfaces that are immediately adjacent the edge 315. Accordingly, the barcode reader 892 can be inclined at a non-zero angle ⊖ (relative to the plane of the slide) and pick up barcode information from this edge-adjacent region.

In some embodiments, instead of a linear barcode 110, a 2D barcode 120 could be printed on the label 810 so that when the label 810 is folded over the edge 315 of substrate 312, the 2D barcode 120 will be visible along the edge 316 of the slide 800. For example, turning now to FIGS. 9a, 9b, and 9c, illustrated therein is an example pathology slide 900 with a barcode (in this example a 2D barcode 120) in two locations, position (a) on the bottom edge 315 of the slide substrate 312 and position (b) on the top surface of slide substrate 312.

In particular, in this example barcodes 120 at both positions (a) and (b) have been printed on a label 910 and then folded over the edge 315, in some cases onto the opposite side or bottom of the slide substrate 312 (i.e., generally wrapping around the slide 900).

FIG. 9a shows an example label 910. The label 910 as shown has a narrow end 911 and is designed to be folded over the bottom edge 315 of the slide 900 (although it will be appreciated that in other embodiments the label 910 could be folded over other edges of the slide 900, such as a top edge 313).

In this example, the label 910 includes text 212 and 2D barcode 120 printed at position (a) within the narrow portion 911 of the label 910, and position (b) the wider portion of label 910.

Turning now to FIG. 9b, slide 900 is shown with a plan view 920, a top end view 930, a bottom end view 940, and right-side view 950 along its length. As will be appreciated, since in this example 2D barcode 120 is printed at locations (a) and (b), the bottom end view 930 shows the 2D barcode 120 at position (a) of the narrow portion 911 of label 910 that has been folded over the edge 315 of the slide 900 while 2D barcode 120 at position (b) is visible on label 910 in plan view 920 of slide 900.

In this example, 2D barcode 120 at position (a) is visible on slide edge 315 of bottom view 940 of slide 900. The 2D barcode 120 at position (b) is visible on top plan view 920 of slide 900. The 2D barcodes 120 at positions (a) and (b) of label 910 can contain the same and/or different relevant information that relates to the slide 900.

FIG. 9c, on the other hand, shows a rear plan view 960, as well as inverted top and bottom views 970, 980 and a left side view 990. The rear plan view 960 in particular shows the portion of the narrow end 911 of label 910 folded over the slide glass substrate 312 onto the back of pathology slide 900. In this example only 2D barcode 120 at position (a) is visible on the end of bottom edge 315 of bottom view 940 of slide 900.

2D Barcode at location (a) can be printed at any position along edge 315. Barcode at location (b) can be printed at any available location on the wider portion of the label. Furthermore one or more 2D barcodes can be printed along edge 315. Similarly more than one barcode can be printed on available space on the wider portion of label 910. In the simplest configuration a single 2D barcode 120 can be printed on label 910 and mounted on edge 315 of slide 900.

The above descriptions are examples of barcode arrangements and by no means limit other arrangements that can include combinations of various barcodes (including 1D and 2D barcodes, or others) printed or otherwise provided along the edges of slides.

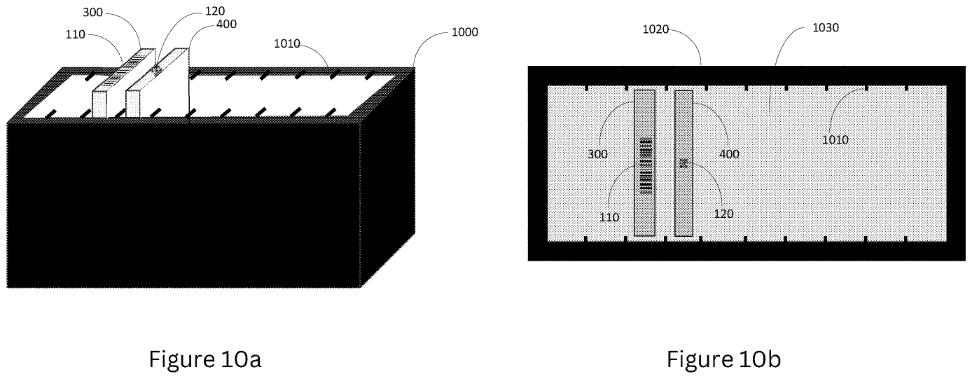

Turning now to FIG. 10a, and 10b, illustrated therein are example diagrams of example pathology slides with linear (1D) and/or 2D barcodes on the edges of slides inside a container 1000 with the barcodes visible for reading.

FIG. 10a is an example perspective diagram of a pathology slide container 1000. In this example, and for illustration purposes, the container is only open on one side, i.e., pathology slides 300 and 400 cannot be accessed from other sides of container 900.

FIG. 10b is a top view of pathology slide container 1000. In this example two slides are shown, slide 300 with 1D barcode 110 on the visible end of slide 300 while slide 400 with 2D barcode 120 on the visible end of slide 400.

Other pathology slide containers like Sakura cassettes, Leica cassettes, and Epredia baskets, or, indeed, containers for slides used in any and various applications, may have at least one side for accessing slides 300 and 400. Slides 300 or 400 are inserted into container 1000 so that the edge of slides 300 or 400 that includes barcodes 110 or 120 along the edge is in the direction of an opening of cassette 1000.

Slides 300 or 400 as shown are inserted into slots 1010 that separate the slides and hold them in place. Slides that are labeled on a plurality of sides as shown in FIGS. 8a, 8b, 8c, 9a, 9b, and 9c above will include barcodes 110 or 120 from any and all sides on those cassettes which have at least one side for accessing slides 300 and 400.

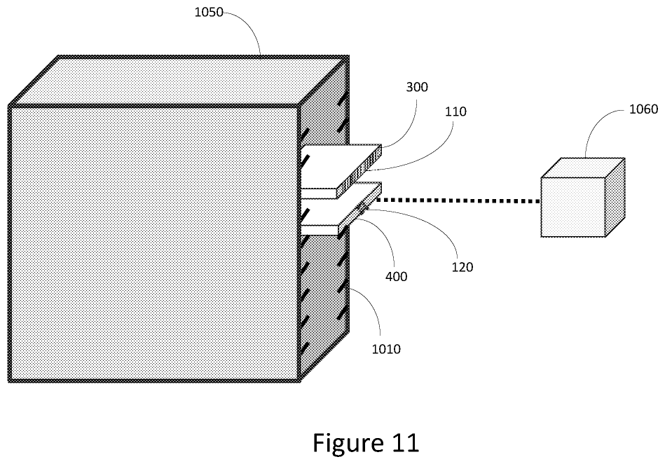

Turning now to FIG. 11, illustrated therein is an example diagram of reading barcodes present along the edges of a plurality of slides that are inserted into a cassette.

In FIG. 11, for example, cassette 1050 (like cassette 1000 in FIG. 10a) is oriented so that the opening thereof is pointing to the right. In this orientation of cassette 1050, pathology slides 300 and 400 are horizontal and are separated and supported by slots 1010. Barcodes 110 and 120 of pathology slides 300 and 400 (respectively) are present along the edges of the slides and visible to the barcode reader 1060 with its sensor facing the opening of the cassette 1050.

In this manner, the barcode reader 1060 can read barcodes 110 and 120 on slides 300, and 400, respectively, generally without needing to move the slides (i.e., the slides can stay within the slide container).

In the case of slides 300 or 400 occupying some or all of the slots 1010 in the cassette 1050 (or even where slides 300 or 400 are directly in contact with each other), the barcode reader 1060 may be capable of reading all barcodes simultaneously.

In another approach, cassette 1050 can be moved relative to the barcode reader 1060 (i.e., along a z-axis) so that each barcode 110 or 120 of slide 300 or 400 is read as it is presented in front of a fixed position barcode reader 1060.

In another approach the barcode reader 1060 may be moved relative to the cassette 1050 so that as the barcode reader moves barcodes 110 or 120 may be read.

One further implementation is a simple linear barcode that can be attached to (or printed on or engraved on) the edge(s) of a slide when the slide is manufactured, containing enough information to index the slide and its image without requiring the entire barcode information to be included in the 1D barcode.

This index barcode would be easy to print or position on any or all edges of the slide, and easy to read. It should include enough information so the 2D information barcode on the slide can be accessed later when that information is needed, but the index barcode contains enough information that one can access the original barcode information as required.

The index barcode may be read on any or all edges of every slide in every slide container when it is loaded into the scanner, so that when the barcode is read, the index number on every slide in the scanner can be automatically connected to the barcode and the position of the slide in the slide holder and which slide holder it is contained in.

One simple barcode could be just the batch number for a batch of new slides followed by a number that tells which slide in the batch this is. For example, a number 099000135 could be an index number for slide batch 99 and slide number 135 (out of 999,999) in the batch.

This way the only change required from the current methodology for handling slides and slide containers is the addition of a step to image a simple linear barcode on one or more edges of each slide (the edge of the end or one or more other edges) and record which slide container it is contained in. In pathology labs, for example, where slide containers such as Sakura cassettes, Epredia baskets, etc. are already indexed, this procedure would improve data collection without negatively affecting the time taken to process slides.

### Definitions

1D barcode (or linear barcode): a one-dimensional barcode or linear barcode consists of a series of vertical bars and spaces of varying widths. These bars represent data by encoding information in the width and spacing of the parallel lines. The information encoded in a 1D barcode is usually limited to numerical or alphanumeric data and is read horizontally by a barcode scanner.

2D barcode: a two-dimensional or 2D barcode is a type of barcode that encodes data both horizontally and vertically, allowing it to store more information than a 1D barcode. Unlike 1D barcodes, which consist of a series of parallel lines, 2D barcodes are often represented as a matrix of square or rectangular patterns, dots, or other shapes. These patterns can encode complex data, including text, URLs, and even entire images. Common types of 2D barcodes include QR codes (Quick Response codes), Data Matrix, and PDF417. They are scanned using specialized 2D barcode readers or smartphones equipped with cameras.

Pathology slide: a pathology slide is a thin, flat, rectangular piece of glass or other material (usually transparent), often measuring 1 inch by 3 inches (25 mm by 75 mm), used to hold and examine biological specimens under a microscope. The thickness of a pathology glass slide typically ranges from 1 mm to 1.2 mm, although other sizes are possible. This thickness provides the necessary durability and stability for handling, while still being thin enough to be compatible with standard microscope stages and objectives. This standard thickness allows the slide to be used efficiently in various types of microscopies including light and fluorescence microscopy.

Pathology slide label: a pathology slide label refers to the identifying information affixed to a microscope slide containing a tissue or cell sample that is being analyzed for diagnostic purposes. This label typically includes but is not limited to critical details that ensure accurate identification and traceability of the sample throughout the diagnostic process. Common elements found on a pathology slide label include patient information: Name, ID number, and other relevant patient identifiers; specimen Information: type of tissue or sample, anatomical site, and possibly a brief description; the date when the sample was collected or prepared; accession number that is a unique identifier assigned to the specimen for tracking purposes. This label ensures that the sample can be accurately linked to the correct patient and medical record, minimizing the risk of errors in diagnosis.

Slide glass substrate: a slide glass substrate (or slide substrate) used in pathology generally refers to glass that is transparent to visible light (400-700) nm. In general, these glass substrates provide a stable and transparent surface that is essential for accurately observing and analyzing biological specimens under a microscope. The dimensions of slide glass substrates can vary dependent on the size of the specimen placed on them. Many slides in pathology are approximately 1 inch by 3 inches (25 mm by 75 mm)×1.0-1.2 mm thick, although other sizes are possible. Slide glass substrates with dimensions of up to 6 inches by 8 inches (150 mm by 200 mm) with thickness of 1.5 mm for whole mount specimens (e.g., breast mastectomy, prostate, brain sections) are also used in pathology. These glass substrates provide a stable and transparent surface that is important for accurately observing and analyzing biological specimens under a microscope or imaging using a digital pathology scanner.

Coverslip: a coverslip is a thin, transparent piece of glass or plastic that is placed over a specimen on a pathology slide. The primary purpose of the coverslip is to protect the specimen from contamination and damage while providing a flat, even surface for viewing under a microscope. The coverslip also helps to preserve the sample, enhance optical clarity, and reduce refraction, allowing for clearer and more accurate visualization of the specimen's details. Coverslips are typically much thinner than the glass slide itself, often measuring between 100 to 200 micrometers (μm) in thickness, allowing them to be nearly invisible under the microscope.

Slide Container: a “slide container” refers to a cassette, a cartridge, a basket, or a custom protective holder or carrier designed to securely hold and transport a plurality of slides that contain tissue samples mounted on them. These containers are used to facilitate the safe handling, storage, and transportation of slides before, during, and after, for example, they are scanned in a digital pathology scanner. Usually, they are rectangular in shape with a minimum one side open/exposed to access the slides for scanning purposes. Examples of pathology slide containers are: Sakura cassette with a slide capacity of twenty 1 inch by 3 inch slides; an Epredia basket with a slide capacity of twenty 1 inch by 3 inch slides; and a Leica cassette with a slide capacity of 30 1 inch by 3 inch slides.

Barcode reader: a barcode reader, also known as a barcode scanner, is a device that captures and decodes the information encoded in a barcode. Barcodes are a series of printed lines or patterns that represent data, typically numbers or letters. The barcode reader uses optical sensors to scan the barcode, convert the reflected light into electrical signals, and then interpret these signals to retrieve the encoded data. This information is then sent to a computer or integrated system for processing, making barcode readers useful in various applications like inventory management, retail checkout, medical tracking and record keeping, and data entry. In addition to optical barcode scanners, computer vision-based approaches can also be used to read barcodes. These systems utilize algorithms and image processing techniques to identify and interpret barcodes from digital images or video frames.

According to some aspects, the described barcodes (i.e., 1D or 2D), may be written or inscribed or labeled or otherwise marked on slide edges or labels affixed to the slide by equipment provided by manufacturers of a) label printing and marking equipment; and/or b) laser marking and etching equipment; and/or c) direct to surface printing equipment, using the concepts, approaches and techniques described herein and by rights offered to and supplied to such manufacturers.

According to some aspects, the described techniques of applying and reading of such edge-applied barcodes can be applied to a multitude of applications across various industries which employ slides, thin plates, and/or other thin objects requiring identification in their processes. This can include but is not limited to reading of edge barcodes within digital pathology scanners; reading of edge barcodes in other pathology lab devices/equipment; reading of edge barcodes in microscopy devices/equipment; reading of edge barcodes in any and all equipment and processes which carry unique data in any form on glass or other transparent plates or slides of any size and which require identification and labeling for the purpose of determining the origins, purpose, and/or details of said data while said glass plates or slides are stored, transported, or processed in a stacked arrangement where generally only edges are visible and accessible without additional handling.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that the term “coupled” used herein indicates that two elements can be directly coupled to one another or coupled to one another through one or more intermediate elements.

Various embodiments have been described herein by way of example only. Various modification and variations may be made to these example embodiments without departing from the spirit and scope of the invention, which is limited only by the appended claims.

We claim:

1. A slide for use with an imaging device, comprising:
a. a first surface for receiving an object of interest thereon; and
b. one or more edges, at least one of the one or more edges having at least one barcode thereon, each barcode sized and shaped to be readable by a barcode reader.

2. The slide of claim 1, wherein the barcode is readable by the barcode reader when the first surface of the slide is at least partially obscured.

3. The slide of claim 2 wherein the barcode is readable when the first surface is at least partially obscured by another slide.

4. The slide of any preceding claim, wherein the object of interest is a tissue sample.

5. The slide of any preceding claim, wherein the barcode is a linear barcode.

6. The slide of any preceding claim, wherein the barcode is a two-dimensional barcode.

7. The slide of any preceding claim, wherein the barcode is printed directly on the slide edge.

8. The slide of any preceding claim, wherein the barcode is printed on a label affixed to the slide edge.

9. The slide of the preceding claim, wherein the label is folded over the slide edge.

10. The slide of the preceding claim, wherein a first portion of the barcode is on the edge of the slide and a second portion of the barcode is on at least one of the first surface of the slide or a second surface of the slide, the second portion of the barcode being adjacent the edge.

11. The slide of any preceding claim, wherein the thickness of the slide edge is between approximately 1.0 to 1.2 mm.

12. The slide of any preceding claim, wherein the slide further comprises a label affixed to the planar surface thereof.

13. The slide of any preceding claim, wherein the barcode includes an index barcode.

14. A slide container including a plurality of slides for use with imaging device, wherein each slide comprises:
a. a first surface for receiving an object of interest thereon; and
b. one or more edges, at least one of the one or more edges having at least one barcode thereon, each barcode sized and shaped to be readable by a barcode reader.

15. The slide container of claim 14, wherein the barcode of each slide is readable by the barcode reader when the first surface of each slide is at least partially obscured by another slide in the slide container.

16. The slide container of claim 14 or claim 15, wherein the object of interest is a tissue sample.

17. The slide container of any one of claims 14-16, wherein the barcode is a linear barcode.

18. The slide container of any one of claims 14-16, wherein the barcode is a two-dimensional barcode.

19. The slide container of any one of claims 14-16, wherein the barcode is printed directly on the slide edge.

20. The slide container of any one of claims 14-16, wherein the barcode is printed on a label affixed to the slide edge.

21. The slide container of claim 20, wherein the label is folded over the slide edge.

22. The slide container of claim 21, wherein a first portion of the barcode is on the edge of the slide and a second portion of the barcode is on at least one of the first surface of the slide or a second surface of the slide, the second portion of the barcode being adjacent the edge.

23. The slide container of any claim 14-22, wherein the barcode reader is capable of reading a plurality of barcodes on a plurality of slides simultaneously.

24. A method of identifying a particular slide in a slide container having a plurality of slides, comprising:
a. scanning at least one barcode on at least one edge of at least one of the plurality of slides;
b. comparing each barcode to a list of known barcodes associated with the plurality of slides; and
c. identifying the particular slide among the list of known barcodes.

25. A method of prioritizing a digital scanning of a tissue sample, comprising:
a. reading a plurality of barcodes, each barcode on one or more edges of one of a plurality of slides located within at least one slide container;
b. determining a desired slide of the plurality of slides based on information associated with the barcode of that desired slide;
c. physically placing the desired slide in a digital scanner; and
d. scanning a tissue sample mounted on the desired slide.

26. A scanner with imaging capabilities, comprising:
a. a cassette receiver for receiving one or more cassettes, each cassette having one or more slides therein, each slide having an object of interest thereon and at least one barcode on at least one edge of the slide;
b. a slide imaging device for generating images of the objects of interest on the one or more slides;
c. a barcode reading device for reading the barcodes on the slides, wherein the barcodes are positioned on the edge of the slides so as to be readable while the slides are still within each cassette;

27. The scanner of claim 26, wherein the barcode reader is operable to read all barcodes of all slides in the scanner.

28. The scanner of one or more of claims 26 and 27 wherein the object of interest is a tissue sample.

29. The scanner of one or more of claims 26 to 28 wherein the scanner is a pathology scanner.
